(19) United States
(12) Patent Application Publication
(10) Pub. No.: US 2019/0279287 A1
(43) Pub. Date: Sep. 12, 2019

(54) Allocation of Mobile Farming Equipment Using Language-Agnostic Message Service

(71) Applicant: HELLO TRACTOR, INC., Washington, DC (US)

(72) Inventor: Jehiel OLIVER, Washington, DC (US)

(73) Assignee: Hello Tractor, Inc., Washington, DC (US)

(21) Appl. No.: 16/312,200

(22) PCT Filed: Jun. 22, 2017
(86) PCT No.: PCT/US2017/038851

§ 371 Date: Dec. 20, 2018

Related U.S. Application Data
(60) Provisional application No. 62/353,187, filed on Jun. 22, 2016.

(51) Int. Cl. G06Q 30/06; G06Q 50/02; G08G 1/00; G06F 16/909; H04L 12/58

(52) U.S. Cl. CPC G06Q 30/0645; G06Q 50/02; H04L 51/046; G08G 1/202; G06F 16/909; G06Q 30/0639

(57) ABSTRACT

The invention herein improves access to affordable farm equipment mechanization for the rural poor, improves their access to productivity enhancing machinery, and aids farmers with efficient cultivation and timely planting. The technology platform ensures that farmer's requests for service are promptly addressed and that equipment generally unused at certain times, in the market, is fully utilized. Using location tracking and usage information, the present invention provides effective allocation of the nearest under-utilized farming equipment between owners (or lessors) and requesting farmers. Moreover, utilizing language-agnostic messaging services greatly enhance the adoption, spread, and utilization of the allocation system disclosed herein.

### FIELD

The present invention relates in general to the field of allocation of mobile farming equipment using language-agnostic messaging, and specifically, to methods and systems for farmers in need of equipment to obtain the use of equipment from farm equipment owners who have available farm equipment.

### BACKGROUND

In developing and underdeveloped countries, there is often a deficiency in farming equipment resulting in farmers failing to maximize the crop and revenue potential from their land. Additionally, farm equipment owners' farming equipment is often under-utilized, either generally or during a particular season, and who therefore fail to maximize their return of investment in the ownership of their farm equipment. Consequently, there is a large desire for and benefit from the sharing of farm equipment between those in need of farm equipment and those who have available or under-utilized farm equipment, when and where possible. There, however, exists a problem with the inability of many farmers to adopt the required technology to enable sharing.

There have been several developments in other areas relating to the allocation and/or sharing of resources. For example, several transportation-for-hire services have developed in recent years, such as those provided by Uber, Inc. and Lyft, Inc. These services allow for customers with smartphones to submit transportation requests using mobile phone applications and identify available automobile owners in the area that are able to transport the customers to their requested destinations. Similarly, car-sharing services such as those provided by Zipcar, Inc. allow customers registered with its service to reserve a car or truck via a mobile phone application or website, who then are directed to available vehicles in the area that the customer can then rent for a specified time.

Farm equipment sharing services also exist, such as those offered by MachineryLink, Inc., whereby customers are able to rent and list farm equipment via a mobile phone application or website. Despite these existing services, a problem in the field persists for farmers located in rural areas that lack access to the internet and/or other technologies required by the prior art.

Unfortunately, none of these advances have reached the rural and remote farming industry. In one instance, it is typically expensive to buy or rent a smartphone and to learn to use the device and other functionalities to communicate a simple request for equipment. In another instance, cellular communication infrastructure in developing and underdeveloped nation is not sufficient to provide consistent higher bandwidth connections necessary for internet use.

### SUMMARY

In one aspect, the invention provides methods and systems for farmers in need of equipment, first users, to be matched with farm equipment owners with available equipment, second users. For example, a farmer in need of certain farming or agricultural equipment may send a request using a processor-based device, such as a mobile phone, notebook computer, desktop computer, PDA, and the like, using non-complex numeric, alphabetic, or alphanumeric messaging, which represents language-agnostic message services, to a networked server that may include various information, such as the farmer's location, equipment needed, and/or contact information. Farm equipment owners also provide certain information to the networked server that may include available farm equipment, the location of available farm equipment, and/or the farm equipment owner's contact information. Upon receiving the farmer's request for equipment, the networked database matches the farmer requesting certain equipment with a farm equipment owner having the requested farm equipment available. By the farmer sending a request using non-complex numeric, alphabetic, or alphanumeric messaging, which represents language-agnostic message services, the request may be received and processed by the networked server even if the farmer is located in an area of limited network or internet connectivity.

In one embodiment, farmers send requests to the networked server including various information relevant to matching available farm equipment. For example, the requests could include the type of farm equipment needed, the duration of requested farm equipment use, the area of farmland for which the farm equipment is needed, the time at which the equipment will be needed, payment information, and the location of the farm. Separately, farm equipment owners with available equipment send various information to the networked server. That information could include the type of equipment, duration of equipment availability, scope of equipment availability, quantity of available equipment, quality of equipment, cost to use available equipment, and location of available equipment. The networked server matches the farmers with farm equipment owners who have the necessary equipment available depending on the requested factors.

In another exemplary implementation, the networked server is also configured for providing alerts to the first user or the second user based on factors regarding equipment maintenance and/or usage. The farm equipment can include location monitoring and usage monitoring components that are capable of providing data to the networked server. Based on this data the networked server alerts the second user via the second processor-based device for communicating when certain usage conditions or levels are reached. The networked server can also provide the second user with real time location and usage data of the farm equipment.

In another exemplary implementation, the networked server is also configured for providing the first user or the second user with farming efficiency and farm equipment use efficiency data and analyses. Using equipment usage and location data, the networked server can provide the first user or the second user with data for optimizing efficiency of farming operations or farm equipment usage. Such efficiency optimization can include maximizing crop output as well as minimizing farm equipment downtime to maximize revenue for farm equipment owners.

### BRIEF DESCRIPTION OF THE DRAWINGS

The accompanying figures, which are included as part of the present specification, illustrate the various implementations of the disclosed system and method. Together with the general description given above and the detailed description of the implementations given below, the figures serve to explain and teach the principles of the system and method disclosed herein.

FIG. 1 illustrates a system for temporary allocation of mobile farming equipment using language-agnostic message service interfaced with a networked database in accordance with an aspect of the invention.

FIG. 2 illustrates part of a method for temporary allocation of mobile farming equipment using language-agnostic message service interfaced with a networked database in accordance with an aspect of the invention.

FIG. 3 illustrates part of a method for temporary allocation of mobile farming equipment using language-agnostic message service interfaced with a networked database in accordance with an aspect of the invention.

### DETAILED DESCRIPTION

The invention disclosed herein improves access to farm equipment for rural farmers, improves their access to productivity enhancing machinery, and aids farmers with efficient cultivation and timely planting. The technology platform ensures that farmer's requests for service are promptly addressed and that equipment generally unused at certain times is more fully utilized. Using location monitoring and usage monitoring information, the invention disclosed herein provides effective allocation of the nearest farming equipment between owners (or lessors) and farmers. Moreover, utilizing language-agnostic messaging services greatly enhances the adoption, spread, and utilization of the allocation system disclosed herein.

For purposes of simplicity in this disclosure, “language-agnostic” means that the language of the request is immaterial to the invention. The reference to “language” as used in “language-agnostic” messaging refers to human communication languages and/or computerized coding languages. Typically, the use of services such as mobile terminated messages and short message service type messages enable predetermined and new shorthand codes for communication, which makes it language-agnostic with reference to human communication languages. Furthermore, the use of mobile terminated messages and short message service type messages reduces reliance on relatively complex user interface applications that are typical in present-day smartphone type devices. For example, the use of software application in languages such as Java® or Swift® is avoided, thereby making the present invention further language-agnostic with reference to high level computerized coding languages. A person of ordinary skill in the art would recognize that certain low level translations occur while using mobile terminated messages and short message service type messages, and that this is part of the invention.

The present invention is a combined hardware and software solution for allocating equipment from owners (or lessors) to requesting farmers in consideration of various criteria—all via language-agnostic electronic communications (e.g. messaging).

This invention is particularly useful to farmers in rural areas because it is capable of functioning under various technologies. By using language-agnostic electronic communications, the system is capable of performing on a multitude of platforms with limited adjustment. For example, in certain regions where there is limited internet connectivity and or smart phone availability, the system can be run using SMS short coded messages for farmers with non-smart phones and access to very limited cellular coverage. Further, the flexibility of the system also allows farmers to request farm equipment wherever and whenever they have access to electronic communication technology. Thus, farmers could make requests when they travel to areas with cellular coverage even though cellular service may not be available on their farms.

In an exemplary implementation, various types of farm equipment are available including tractors, harvesters, sprayers, hay handlers, foragers, planters, seeders, cutters, mowers, shredders, spreaders, loaders, tillers, tiller attachments, irrigation pumps, and trailers. The farm equipment may additionally include one or more systems for locating the farm equipment, for example, global positioning (GPS), long-range navigation (LORAN), automatic identification system (AIS), or global system for mobile communication (GSM) triangulation type transmitters or transceivers, or telematics trackers. Retrofit tracking units may be fit into tractors allowing the system of the invention to identify and track the location coordinates of each tractor in the field. The information is stored on a database that is connected to a networked server and shared with famers via the language-agnostic messaging platform.

In one embodiment, the farm equipment is a standardized tractor capable of multiple farming functions. For example, in one embodiment, the tractor could be a multi-purpose tractor that can be fitted with different attachments depending on the task to be performed. An example of such a tractor is the John Deere Series 5045D Utility Tractor. This tractor is capable of handling by farmers with little or no training and is capable of functioning with a plurality of attachments including tiller, combine, sprayer, baler, scraper, and seeding accessories. This tractor is relatively low maintenance and does not require an expert mechanic for most repairs. In another embodiment, these standardized tractors are owned and maintained by one entity. In this embodiment, a fleet of tractors is available for use and can be maintained at a higher scale. This is especially useful in rural areas because the parts for one type of tractor can be acquired in greater quantities and interchanged between tractors as necessary.

In an aspect of the present invention, the information from the users and the equipment monitoring information, along with other data inputs, are available to equipment owners (or lessors or suppliers) and to other users via language-agnostic messaging queries. The networked server is configured via an application programming interface (API) to work with phone, website, and database applications. In an exemplary implementation the language-agnostic messaging is configured to secure information from the networked server, including information for availability status (e.g., in use, en route to work site, scheduled for future use, and/or available for job assignment), working status (e.g., location, area or acreage farmed, fuel usage, tracking, reporting, and task scheduling and viewing, and equipment performance data such as quantity of crops harvested, amount of seeds and/or fertilizer spread, etc.); and maintenance status (e.g., recommendation of scheduling maintenance for the farm equipment or equipment components based on duration of use of equipment, distance of use of equipment, and the like, depending on the equipment type). The language-agnostic messaging also allows sign in, registration; and system testing that runs on a daily basis.

In an exemplary implementation, a method for allocating farming equipment using language-agnostic message service interfaced with a networked database is disclosed. The method includes receiving from a first processor-based device, at a networked server identified by a unique shortcode, a request in the form of one or more first language-agnostic messages corresponding to a first user. The request typically includes first user information of one or more of the following unique identifier fields: (a) a user unique identifier for a user, (b) a device unique identifier for a processor-based device, (c) a location unique identifier for the processor-based device or a second device, the second device corresponding to an equipment location or a physical location for the user, and (d) one or more equipment-specific unique identifiers for the user. The method includes aggregating the above fields, using an application programming interface (API) on the networked server, to form the first request. The method of aggregating includes sub-functions, including parsing the one or more language-agnostic message service of the first user for the first user information and saving the parsed unique identifiers of the first user to the networked database. The parsed unique identifiers in the networked database are then associated with a primary database key to complete the registration of the first user information. Matching is performed on the networked server, using pre-registered second user information to compare against the first user information. The pre-registered second user information includes the same unique identifier fields as the first user and essentially requiring one or more entries for the one or more equipment-specific unique identifiers field for the one or more second users.

In an implementation, the matching function determines that one or more second users exist in the networked database with ownership of corresponding equipment to the first user information in the field of the one or more equipment-specific unique identifiers. The matching function also determines that the corresponding equipment is working and available for use, and that the one or more second users are within a predetermined distance of the first user. The distance determination is made by matching the location unique identifier fields of the first user and the one or more second users. A further part of the matching function determines that the one or more second users are willing to deliver, or to have delivered with or without an equipment operator, their corresponding equipment to the first user and that the one or more second users are available to communicate directly with the first user using corresponding one or more second device-unique identifiers in the pre-registered second user information. A providing function, from the networked server to the processor-based device, provides the pre-registered second user information when a determination is made that the matching satisfies a predetermined requirement. This enables the first user to communicate with the matched one or more second users using one or more second language-agnostic messages, and to receive temporary allocation of mobile farming equipment of the matched one or more second users at a physical location identified by the location unique identifier of the first user.

In another exemplary implementation, a system for temporary allocation of mobile farming equipment using language-agnostic message service interfaced with a networked database is disclosed. The implementation includes a first processor-based device for communicating with a networked server identified by a unique shortcode. The communication from the first processor-based device is a request in the form of one or more first language-agnostic messages corresponding to a first user. The request can include first user information and typically includes first user information of one or more of the following unique identifier fields: (a) a user unique identifier for a user, (b) a device unique identifier for a processor-based device, (c) a location unique identifier for the processor-based device or a second device, the second device corresponding to an equipment location or a physical location for the user, and (d) one or more equipment-specific unique identifiers for the user. The networked server is configured with an application programming interface (API) that executes and configures the networked server for aggregating the first request. The API aggregating function parses the one or more language-agnostic message service of the first user for the first user information. Aggregating functions to save the parsed unique identifiers of the first user to the networked database and associates the parsed unique identifiers with a primary database key. The saving function completes the registration of the first user information.

The networked server is also configured for matching pre-registered second user information with the first user information. The pre-registered second user information includes information for the same unique identifier fields as the first user and essentially requiring one or more entries for the one or more equipment-specific unique identifiers field for the one or more second users. The networked server's matching function determines that one or more second users exist in the networked database with ownership of corresponding equipment to the first user information in the field of the one or more equipment-specific unique identifiers. The matching function also determines that the corresponding equipment is working and available for use and optionally whether the one or more second users are within a predetermined distance of the first user based on matching the location unique identifier fields of the first user and the one or more second users. A further function of the matching is to determine that the one or more second users are willing to deliver, or to have delivered with or without an equipment operator, their corresponding equipment to the first user, and that the one or more second users are available to communicate directly with the first user using corresponding one or more second device-unique identifiers in the pre-registered second user information. The networked server is also configured for providing to the processor-based device, the pre-registered second user information when a determination is made that the matching satisfies a predetermined requirement. This determination enables the first user to communicate with the matched one or more second users using one or more second language-agnostic messages, and also to receive temporary allocation of mobile farming equipment of the matched one or more second users at a physical location identified by the location unique identifier of the first user.

In an aspect of the invention farmers may register with the networked server by providing data that is aggregated on the networked database via the networked server. The data, also referred to herein as the user information, includes phone number, name or username, and location coordinates. Similar information for equipment owners (or lessors or suppliers), also referred to as the user information, is aggregated by the system of the present invention. The location information of the farm may be communicated to the networked server for first user registration purposes by means of a global positioning (GPS) or global system for mobile communication (GSM) triangulation type transmitters or transceivers, or telematics trackers of the first processor-based device or may be independently determined and communicated to the networked database.

In another aspect of the invention, the farming equipment allocation platform includes a website application on a networked server that allows farmers to request tilling or any other services in the future via language-agnostic messaging. The combination of the website applications, booking, tracking units and the equipment allows farmers to access farm equipment from a device other than a smartphone (e.g., a non-feature phone or a pager).

In yet another aspect, the invention uses the language-agnostic messaging to interface with a messaging gateway. In such aspects, the networked server is not a single system component but is one or more components, with one being a messaging gateway, another being an application server. In the messaging gateway application, the phone number of the requesting farmer is a device unique identifier that is used as the registered identifier for the requesting farmer. Farmers pre-registered in the database of the present invention may provide a language-agnostic message without the device unique identifier, because the messaging gateway application is configured to retrieve this information from a received message. Upon receipt of a language-agnostic message, the messaging gateway application links the phone number to the specific farmer and their location coordinates (also referred to herein as the location unique identifier). Alternatively or concurrently, a name or username (also referred to herein as the user unique identifier), is applicable to identify a farmer, owner, and lessor.

In an exemplary implementation, the present system is configured to identify the nearest available and viable equipment matching the requested equipment using a matching algorithm, which is detailed below. An owner for the equipment is identified by the matching algorithm, which considers several factors, including the distance of the equipment (or owner) from requesting farmer's location; the availability of the equipment, including modification status (e.g., the applicable equipment attachment related to the service request—i.e., tiller attachment, irrigation pump, trailer, etc.); and the availability of the farmer to communicate and deliver the equipment to the location of the requesting farmer.

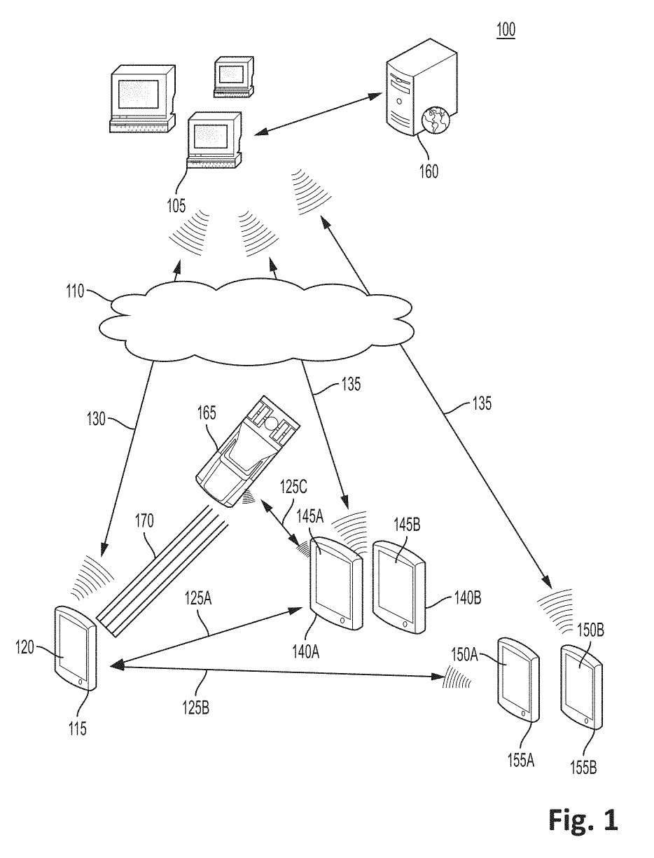

FIG. 1 illustrates a system 100 for temporary allocation of mobile farming equipment 165 using language-agnostic message service interfaced with a networked database in accordance with an aspect of the invention.

In one aspect of the invention, a system 100 for temporary allocation of mobile farming equipment 165 using language-agnostic message service interfaced with a networked database 160 is disclosed. The implementation includes a first processor-based device 115 for communicating 130 via a network 110 with a networked server 105 identified by a unique shortcode. Network 110 maybe a GSM®, Code Division Multiple Access (CDMA®), or WiFi® network. In an example, the unique shortcode is a shortcode phone number for routing the language-agnostic message to the networked server. Further, networked server 105 is illustrated as more than one server device, but may be a unified device configured for performing the functions disclosed herein using APIs, software applications, or embedded code. Alternatively, each server in the networked server 105 is designed for a particular function—e.g., a forwarding networked server, a messaging gateway, an application server, a load balancing server, etc.

The communication 130 from the first processor-based device 115 is a request in the form of one or more first language-agnostic messages that is typed on screen 120 and that corresponds to a first user. In an implementation of the invention, the language-agnostic messages are coded messages in a predetermined format. For example, a predetermined format of numerical codes, alphabetical codes, and alphanumerical codes may be used to determine the equipment sought, to determine availability, ownership, or lessor status, for maintenance status, distance information, and other pertinent information. In such implementations, the need to write a full text request is removed. The request from the first processor-based device 115 typically includes first user information of one or more of the following unique identifier fields: (a) a user unique identifier for a user, (b) a device unique identifier for a processor-based device, (c) a location unique identifier for the processor-based device or a second device 165, the second device corresponding to an equipment location or a physical location for the user, and (d) one or more equipment-specific unique identifiers for the user.

In an aspect of the invention, the user unique identifier and the one or more equipment-specific unique identifiers are in the form of numbers, alphabets, or alphanumeric characters. In another aspect, the device unique identifier is a phone number and the processor-based device is a pager or phone. In yet another aspect, the location unique identifier includes location coordinates from a Global Positioning System (GPS) or a Global System for Mobile Communications (GSM) triangulation. Further, in an example, the first processor-based device 115 and the second processor based devices 140A-B & 155A-B include global positioning system (GPS) and/or GSM triangulation capabilities. Seconds users 145A-B & 150A-B correspond to second processor-based devices 140A-B & 155A-B. In another example of the invention, the first processor-based device 115 and the second processor-based device 140 or 155 communicate 135 GPS or GSM location information to the networked server 105 or to pertinent tracking servers networked with the networked server 105. In yet another example, the second processor-based device is a farm equipment with a modification to allow for location tracking or is an original manufacturer standard equipment with pre-installed location tracking. Additionally, in another example, the unique location information associated with the first processor-based device is independently be determined and communicated to the networked database.

In exemplary embodiments, the one or more equipment-specific unique identifiers for the user includes information about user's capability to: operate, maintain, and fix equipment. This allows receiving farmers to widen their choices, if they can operate, maintain or fix certain equipment that may have been otherwise set aside.

The networked server 105 is configured with an application programming interface (API) that executes and configures the networked server for aggregating the first request 130. The API aggregating function parses the one or more language-agnostic message service of the first user for the first user information. Aggregating functions to save the parsed unique identifiers of the first user to the networked database 160 and associates the parsed unique identifiers with a primary database key. The saving function completes the registration of the first user information. In an example of the databasing aspect of the invention, the primary database key is the user unique identifier or the device unique identifier.

The networked server 105 is also configured for matching pre-registered second user information with the first user information. The pre-registered second user information includes information for the same unique identifier fields as the first user and essentially requiring one or more entries for the one or more equipment-specific unique identifiers field for the one or more second users. The networked server's matching function determines that one or more second users exist in the networked database 160 with ownership of corresponding equipment (e.g., 140A owning equipment 165) to the first user information in the field of the one or more equipment-specific unique identifiers. The matching function also determines that their corresponding equipment 165 is working and available for use and that the one or more second users are within a predetermined distance 170 of the first user 115 based on matching the location unique identifier fields of the first user 115 and the one or more second users 145-150.

In certain aspects of the invention, the one or more equipment-specific unique identifiers include model identifiers, manufacturer identifiers, and modification identifiers for farm equipment. In a further example, the modification identifiers for farm equipment include information on: any changes to a manufacturer original equipment, availability status, maintenance status, and working status.

A further function of the matching is to determine that the one or more second users 145-150 are willing to deliver, or to have delivered with or without an equipment operator, their corresponding equipment to the first user 115, and that the one or more second users 145-150 are available to communicate 125A-B directly with the first user 120 using corresponding one or more second device-unique identifiers in the pre-registered second user information. In an example of the matching process, the networked server for matching is configured to perform matching using string matching algorithm to match the one or more equipment-specific unique identifiers of the first and one or more second users. For example, the string matching algorithm includes: (a) matching characters in the same order as provided in the one or more equipment-specific unique identifiers of the first and one or more second users; (b) matching characters with wildcards in the same order as provided in the one or more equipment-specific unique identifiers of the first and one or more second users; and (c) matching the most number of characters in any order from the one or more equipment-specific unique identifiers of the first and one or more second users.

In an example, the matching process contemplates matching the user's capability with an equipment status of the existing one or more second users. The equipment status is indicated in the one or more equipment-specific unique identifiers of the existing one or more second users and includes maintenance status and working status for one or more equipment. In another example, the one or more equipment-specific unique identifiers for the user includes information about: (a) the user's capability to: communicate with other users, (b) the user's type of processor-based device, (c) the user's distance range of delivery, and (d) the user's availability to deliver one or more farm equipment in the user's range

The networked server 105 is also configured for providing 130 to the processor-based device 115, the pre-registered second user information when a determination is made that the matching satisfies a predetermined requirement. This determination enables the first user to communicate 125A-C with the matched one or more second users using one or more second language-agnostic messages, and also to receive temporary allocation of mobile farming equipment (e.g., equipment 165) of the matched one or more second users 145 at a physical location identified by the location unique identifier of the first user 120.

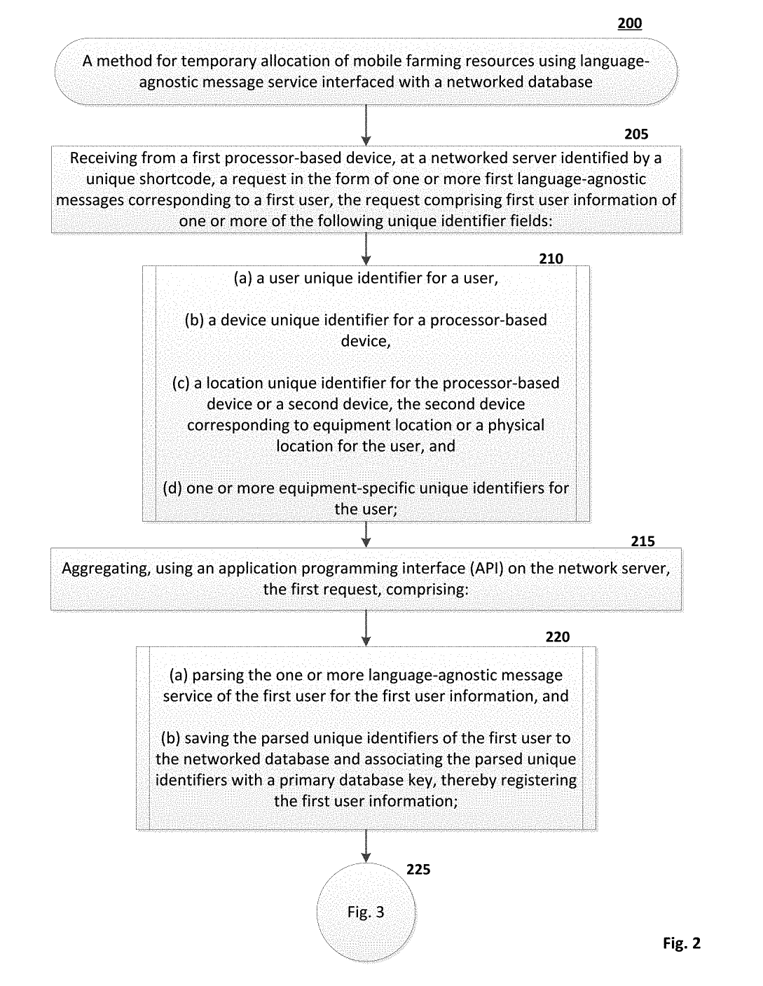

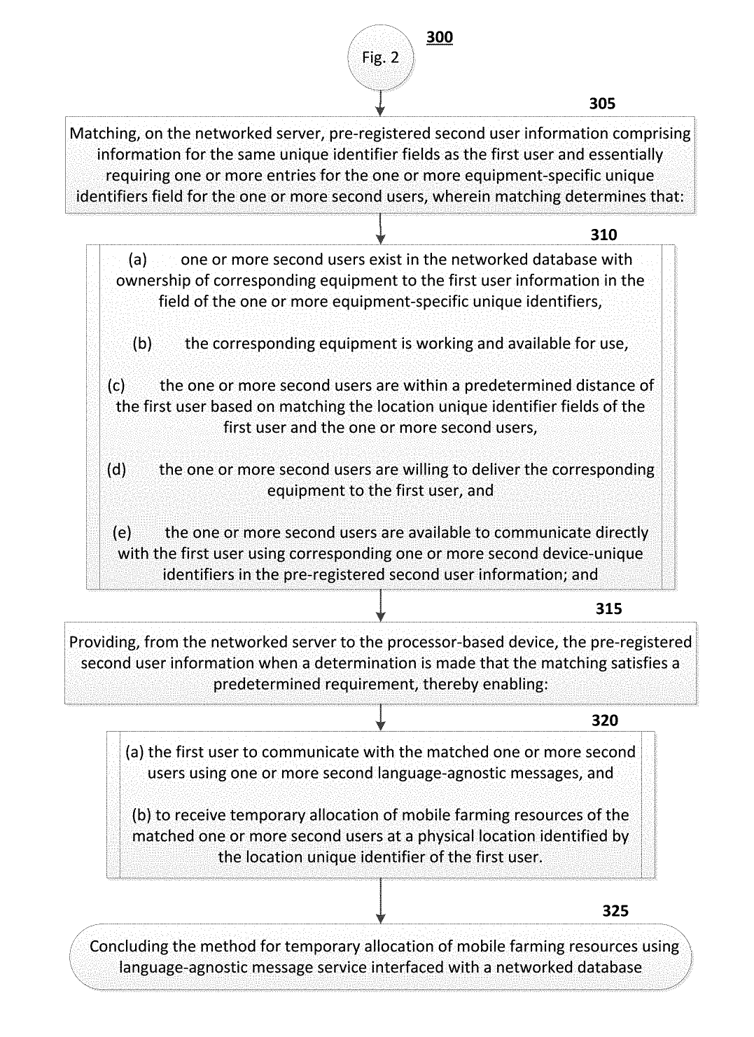

FIGS. 2-3 illustrates a method 200-300 for temporary allocation of mobile farming equipment using language-agnostic message service interfaced with a networked database in accordance with an aspect of the invention.

In yet another aspect of the invention, a method 200-300 for temporary allocation of mobile farming equipment using language-agnostic message service interfaced with a networked database is disclosed. In one implementation, the method 200 is applicable to configure the system 100.

The method 200 includes a receiving function 205 for receiving from a first processor-based device, at a networked server identified by a unique shortcode, a request in the form of one or more first language-agnostic messages corresponding to a first user. The request is illustrated in sub-process 210, which typically includes first user information of one or more of the following unique identifier fields: (a) a user unique identifier for a user, (b) a device unique identifier for a processor-based device, (c) a location unique identifier for the processor-based device or a second device, the second device corresponding to an equipment location or a physical location for the user, and (d) one or more equipment-specific unique identifiers for the user.

The method 200 includes functions for aggregating, using an application programming interface (API) on the networked server, the first request. This is illustrated in block 215. The method of aggregating includes sub-functions illustrated via sub-process 220, including parsing the one or more language-agnostic message service of the first user for the first user information and saving the parsed unique identifiers of the first user to the networked database. The parsed unique identifiers in the networked database are then associated with a primary database key to complete the registration of the first user information. Further functions of the networked server carry over from element 225 to element 300.

The matching function of block 305 configures the networked server for matching, using pre-registered second user information, to compare against the first user information. The pre-registered second user information includes the same unique identifier fields as the first user and essentially requiring one or more entries for the one or more equipment-specific unique identifiers field for the one or more second users.

In an implementation, the matching function 305 includes sub-processes 310. The sub-processes 310 determines that one or more second users exist in the networked database with ownership of corresponding equipment to the first user information in the field of the one or more equipment-specific unique identifiers. The matching function also determines that the corresponding equipment is working and available for use, and that the one or more second users are within a predetermined distance of the first user. The distance determination is made by matching the location unique identifier fields of the first user and the one or more second users. A further part of the matching function determines that the one or more second users are willing to deliver their corresponding equipment to the first user, and that the one or more second users are available to communicate directly with the first user using corresponding one or more second device-unique identifiers in the pre-registered second user information.

A step to provide the pre-registered second user information when a determination is made that the matching satisfies a predetermined requirement is illustrated via block 315, which provides the second user information, from the networked server to the processor-based device. This enables certain sub-process results illustrated in block 320. In an example, the sub-process 320 enables the first user to communicate with the matched one or more second users using one or more second language-agnostic messages, and to receive temporary allocation of mobile farming equipment of the matched one or more second users at a physical location identified by the location unique identifier of the first user. Block 325 concludes the method 200-300 for temporary allocation of mobile farming equipment using language-agnostic message service interfaced with a networked database in accordance with an aspect of the invention.

The exemplary methods and acts described in the implementations presented previously are illustrative, and, in alternative implementations, certain acts can be performed in a different order, in parallel with one another, omitted entirely, and/or combined between different exemplary implementations, and/or certain additional acts can be performed without departing from the scope and spirit of the disclosure. Accordingly, such alternative implementations are included in the disclosures described herein.

The exemplary implementations can be used with computer hardware and software that perform the methods and processing functions described above. Exemplary computer hardware include smart phones, tablet computers, notebooks, notepad devices, personal computers, personal digital assistances, and any computing device with a processor and memory area. As will be appreciated by those having ordinary skill in that art, the systems, methods, and procedures described herein can be embodied in a programmable computer, computer executable software, or digital circuitry. The software can be stored on computer readable media. For example, “computer-readable code,” “software application,” “software module,” “scripts,” and “computer software code” are software codes used interchangeably for the purposes of simplicity in this disclosure. Further, “memory product,” “memory,” “computer-readable code product” and storage can include such media as floppy disk, RAM, ROM, hard disk, removable media, flash memory, memory stick, optical media, magneto-optical media, CD-ROM, etc.

In another implementation, the networked server is also configured for providing alerts to the second user based on factors including maintenance and/or usage. The farm equipment is equipped with location tracking and usage tracking components that are capable of providing data to the networked server. Based on this data the networked server alerts the second user via the second processor-based device for communicating when certain usage milestones are reached. For example, the networked server can provide the second user with alerts regarding the acreage of farm land operated on by the farm equipment (e.g., hectares tilled). In calculating the acreage of farm equipment use, the networked server may also be able to distinguish and discount the area covered by non-operating, transitory farm equipment (e.g., traveling between job sites) from the area covered by farm equipment performing a farming function. One exemplary technique to accomplish this is spatial data clustering, whereby noisy or low-density GPS coordinates generated from non-operation farm equipment travel are separated from high density GPS coordinates generated from actual farm equipment operation. The networked server is also optionally capable of matching the second user with a company to maintain the farm equipment. Using this data, the networked server can also provide the second user with real time location and usage updates of the farm equipment.

In another embodiment, the farm equipment owner or lessor can define a serviceable area or perimeter around the location of the farm equipment that defines an area in which a second user or a farm equipment operator can accept farm equipment requests. Using this feature, the farm equipment owner or lessor can limit the range in can travel to a given work site.

In another embodiment of this invention, the networked server is also configured for providing either the first user or the second user with farm plot usage and farm equipment efficiency metrics. Using the usage and location data, the networked server can provide either the first or second user with analytics for optimizing the usage of the equipment and the efficiency for working the farm.

In another embodiment of this invention, the networked server is configured to provide a user with fleet management tools. Based on the usage status of the various farm equipment identified in the server, the networked server can provide fleet management services to a user based on a subset or the entirety of the fleet of farm equipment. The fleet management services can include monitoring registered farmers and their respective plots to optimize allocation of farming equipment during various seasons, utilizing weather forecasts to optimize allocation of farming equipment, tracking revenue generated attributable to allocated farming equipment and/or the farming equipment operator, farm equipment usage and/or revenue threshold alarms to maintain farm equipment ownership or financing viability, optimizing the allocation of specific equipment for specific work based on location, required maintenance, or future user needs.

Although specific implementations have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary implementations, in addition to those described above, can be made by person of ordinary skill in the art, having the benefit of the present disclosure, without departing from the spirit and scope of the disclosure defined in the following claims, the scope of which is to be accorded the broadest interpretation so as to encompass such modifications and equivalent structures.

What is claimed is:

1. A method for temporary allocation of mobile farming equipment using language-agnostic message service interfaced with a networked database, the method comprising:
receiving from a first processor-based device, at a networked server identified by a unique shortcode, a request in the form of one or more first language-agnostic messages corresponding to a first user, the request comprising first user information of one or more of the following unique identifier fields:
a user unique identifier for a user,
a device unique identifier for a processor-based device,
a location unique identifier for the processor-based device or a second device, the second device corresponding to an equipment location or a physical location for the user, and
one or more equipment-specific unique identifiers for the user;
aggregating, using an application programming interface (API) on the networked server, the first request, comprising:
parsing the one or more language-agnostic message service of the first user for the first user information, and
saving the parsed unique identifiers of the first user to the networked database and associating the parsed unique identifiers with a primary database key, thereby registering the first user information;
matching, on the networked server, pre-registered second user information comprising information for the same unique identifier fields as the first user and essentially requiring one or more entries for the one or more equipment-specific unique identifiers field for the one or more second users, wherein matching determines that:
(a) one or more second users exist in the networked database with ownership of corresponding equipment to the first user information in the field of the one or more equipment-specific unique identifiers,
(b) the corresponding equipment is working and available for use,
(c) the one or more second users are within a predetermined distance of the first user based on matching the location unique identifier fields of the first user and the one or more second users,
(d) the one or more second users are willing to deliver their corresponding equipment to the first user, and
(e) the one or more second users are available to communicate directly with the first user using corresponding one or more second device-unique identifiers in the pre-registered second user information; and
providing, from the networked server to the processor-based device, the pre-registered second user information when a determination is made that the matching satisfies a predetermined requirement, thereby enabling:
the first user to communicate with the matched one or more second users using one or more second language-agnostic messages, and
to receive temporary allocation of mobile farming equipment of the matched one or more second users at a physical location identified by the location unique identifier of the first user.

2. The method of claim 1, wherein the networked server is one or more of a forwarding networked server, a messaging gateway, an application server, and a load balancing server.

3. The method of claim 1, wherein the one or more first language-agnostic messages and the one or more second language-agnostic messages are mobile terminated messages or short message service type messages.

4. The method of claim 1, wherein the language-agnostic messages are coded messages in a predetermined format.

5. The method of claim 1, wherein the unique shortcode is a shortcode phone number.

6. The method of claim 1, wherein the user unique identifier and the one or more equipment-specific unique identifiers are in the form of numbers, alphabets, or alphanumeric characters.

7. The method of claim 1, wherein the device unique identifier is phone number.

8. The method of claim 1, wherein the processor-based device is a pager or phone.

9. The method of claim 1, wherein the location unique identifier includes location coordinates from a Global Positioning System (GPS) or a Global System for Mobile Communications (GSM) triangulation.

10. The method of claim 1, wherein the processor-based device, the first processor-based device, and the second device include global positioning system (GPS) and/or GSM triangulation capabilities.

11. The method of claim 10, wherein the processor-based device, the first processor-based device, and the second device communicate GPS or GSM location information to the networked server or to pertinent tracking servers networked with the networked server.

12. The method of claim 1, wherein the primary database key is the user unique identifier or the device unique identifier.

13. The method of claim 1, wherein the one or more equipment-specific unique identifiers include model identifiers, manufacturer identifiers, and modification identifiers for farm equipment.

14. The method of claim 13, wherein the modification identifiers for farm equipment includes information on: any changes to a manufacturer original equipment, availability status, maintenance status, and working status.

15. The method of claim 1, wherein the matching is performed using string matching algorithm to match the one or more equipment-specific unique identifiers of the first and one or more second users, the string matching algorithm comprising:
a. matching characters in the same order as provided in the one or more equipment-specific unique identifiers of the first and one or more second users;
b. matching characters with wildcards in the same order as provided in the one or more equipment-specific unique identifiers of the first and one or more second users; and
c. matching the most number of characters in any order from the one or more equipment-specific unique identifiers of the first and one or more second users.

16. The method of claim 1, wherein the one or more equipment-specific unique identifiers for the user includes information about user's capability to: operate, maintain, and fix equipment.

17. The method of claim 16, wherein the matching contemplates matching the user's capability with an equipment status of the existing one or more second users, wherein
the equipment status is indicated in the one or more equipment-specific unique identifiers of the existing one or more second users and
includes maintenance status and working status for one or more equipment.

18. The method of claim 1, wherein the one or more equipment-specific unique identifiers for the user comprises information about:
the user's capability to communicate with other users,
the user's type of processor-based device,
the user's distance range of delivery, and
the user's availability to deliver one or more farm equipment in the user's range.

19. The method of claim 1, wherein the second device is an equipment modified with a location tracking device or an original equipment with a preinstalled location tracking device.

20. The method of claim 14, wherein the working status includes measurement of area operated on by farm equipment.

21. The method of claim 20, wherein the measurement of area operated on by farm equipment excludes area attributed to non-farming operation of farm equipment.

22. The method of claim 21, wherein the measurement of area operated on by farm equipment is calculated using spatial data clustering.

23. A system for temporary allocation of mobile farming equipment using language-agnostic message service interfaced with a networked database, the system comprising:
a first processor-based device for communicating with a networked server identified by a unique shortcode, a request in the form of one or more first language-agnostic messages corresponding to a first user, the request comprising first user information of one or more of the following unique identifier fields:
a user unique identifier for a user,
a device unique identifier for a processor-based device,
a location unique identifier for the processor-based device or a second device, the second device corresponding to an equipment location or a physical location for the user, and
one or more equipment-specific unique identifiers for the user;
the networked server executing an application programming interface (API) for aggregating the first request, comprising:
parsing the one or more language-agnostic message service of the first user for the first user information, and
saving the parsed unique identifiers of the first user to the networked database and associating the parsed unique identifiers with a primary database key, thereby registering the first user information;
the networked server for matching pre-registered second user information comprising information for the same unique identifier fields as the first user and essentially requiring one or more entries for the one or more equipment-specific unique identifiers field for the one or more second users, wherein matching determines that:
(f) one or more second users exist in the networked database with ownership of corresponding equipment to the first user information in the field of the one or more equipment-specific unique identifiers,
(g) the corresponding equipment is working and available for use,
(h) the one or more second users are within a predetermined distance of the first user based on matching the location unique identifier fields of the first user and the one or more second users,
(i) the one or more second users are willing to deliver their corresponding equipment to the first user, and
(j) the one or more second users are available to communicate directly with the first user using corresponding one or more second device-unique identifiers in the pre-registered second user information; and
the networked server for providing to the processor-based device, the pre-registered second user information when a determination is made that the matching satisfies a predetermined requirement, thereby enabling:
the first user to communicate with the matched one or more second users using one or more second language-agnostic messages, and
to receive temporary allocation of mobile farming equipment of the matched one or more second users at a physical location identified by the location unique identifier of the first user.

24. The system of claim 23, wherein the networked server is one or more of a forwarding networked server, a messaging gateway, an application server, and a load balancing server.

25. The system of claim 23, wherein the one or more first language-agnostic messages and the one or more second language-agnostic messages are mobile terminated messages or short message service type messages.

26. The system of claim 23, wherein the language-agnostic messages are coded messages in a predetermined format.

27. The system of claim 23, wherein the unique shortcode is a shortcode phone number.

28. The system of claim 23, wherein the user unique identifier and the one or more equipment-specific unique identifiers are in the form of numbers, alphabets, or alphanumeric characters.

29. The system of claim 23, wherein the device unique identifier is phone number.

30. The system of claim 23, wherein the processor-based device is a pager or phone.

31. The system of claim 23, wherein the location unique identifier includes location coordinates from a Global Positioning System (GPS) or a Global System for Mobile Communications (GSM) triangulation.

32. The system of claim 23, wherein the processor-based device, the first processor-based device, and the second device include global positioning system (GPS) and/or GSM triangulation capabilities.

33. The system of claim 32, wherein the processor-based device, the first processor-based device, and the second device communicate GPS or GSM location information to the networked server or to pertinent tracking servers networked with the networked server.

34. The system of claim 23, wherein the primary database key is the user unique identifier or the device unique identifier.

35. The system of claim 23, wherein the one or more equipment-specific unique identifiers include model identifiers, manufacturer identifiers, and modification identifiers for farm equipment.

36. The system of claim 35, wherein the modification identifiers for farm equipment includes information on: any changes to a manufacturer original equipment, availability status, maintenance status, and working status.

37. The system of claim 23, wherein the networked server for matching is configured to perform matching using string matching algorithm to match the one or more equipment-specific unique identifiers of the first and one or more second users, the string matching algorithm comprising:
a. matching characters in the same order as provided in the one or more equipment-specific unique identifiers of the first and one or more second users;
b. matching characters with wildcards in the same order as provided in the one or more equipment-specific unique identifiers of the first and one or more second users; and
c. matching the most number of characters in any order from the one or more equipment-specific unique identifiers of the first and one or more second users.

38. The system of claim 23, wherein the one or more equipment-specific unique identifiers for the user includes information about user's capability to: operate, maintain, and fix equipment.

39. The system of claim 38, wherein the networked server for matching is configured to match the user's capability with an equipment status of the existing one or more second users, wherein
the equipment status is indicated in the one or more equipment-specific unique identifiers of the existing one or more second users and
includes maintenance status and working status for one or more equipment.

40. The system of claim 23, wherein the one or more equipment-specific unique identifiers for the user comprises information about:
the user's capability to communicate with other users,
the user's type of processor-based device,
the user's distance range of delivery, and
the user's availability to deliver one or more farm equipment in the user's range.

41. The system of claim 23, wherein the second device is an equipment modified with a location tracking device or an original equipment with a preinstalled location tracking device.

42. The system of claim 36, wherein the working status includes measurement of area operated on by farm equipment.

43. The method of claim 42, wherein the measurement of area operated on by farm equipment excludes area attributed to non-farming operation of farm equipment.

44. The method of claim 43, wherein the measurement of area operated on by farm equipment is calculated using spatial data clustering.
